(19) United States
(12) Patent Application Publication
(10) Pub. No.: US 2021/0248680 A1
(43) Pub. Date: Aug. 12, 2021

(54) SYSTEM AND METHOD FOR NORMALIZING AND PROCESSING ACCOUNT DATA FROM MULTIPLE SERVER PLATFORMS

(71) Applicant: Keya Lena Financial Consulting, New York, NY (US)

(72) Inventor: Nicole Perrotta, New York, NY (US)

(21) Appl. No.: 17/169,972

(22) Filed: Feb. 8, 2021

Related U.S. Application Data
(60) Provisional application No. 62/970,767, filed on Feb. 6, 2020.

(51) Int. Cl. G06Q 40/06; G06Q 40/02; G06Q 40/04

(52) U.S. Cl. CPC G06Q 40/06; G06Q 40/04; G06Q 40/02

(57) ABSTRACT

A system for processing account data from multiple server platforms that are associated with a retail investor's portfolio, the system comprising a processor, and a memory having executable instructions stored thereon that when executed by the processor cause the processor to retrieve account information data from a financial institution server by using a client data aggregator that accesses the account information data at the financial institution server through an application programming interface, normalize the account information data to a schema by formatting the retrieved data into data fields suitable for processing according to a given data format, analyze the normalized account information data on the basis of cost and quality by using market data from a third-party database, compare the analysis of the normalized account information data with data from a industry standards database, generate a report on findings based on the comparison, and generate recommendations based on the report.

### CROSS REFERENCE TO RELATED APPLICATION

This application claims the priority of U.S. Provisional Application No. 62/970,767, entitled “SYSTEM AND METHOD FOR IDENTIFYING INVESTMENT COSTS,” filed on Feb. 6, 2020, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to identifying costs related to a retail wealth management investor's portfolio and investments.

### Description of the Related Art

There are generally well-known and easily identifiable, recognizable, or transparent costs such as asset-based advisory fees, commissions, origination fees, asset management fees and mutual fund expense ratios. Then there are the less understood and less transparent costs such as bond mark-ups/downs, sales loads, trading costs, conduit expenses etc. As well, there are costs related to the executions, often disadvantaged, that wealth management investors often experience which are complicated to identify and aggregate with the information provided to them in any of their reporting and communications from their investment bank or advisor. Many retail investors do not fully understand what they are paying and how that fits into their overall financial picture, e.g., income statement/expenses, and is often ignored because they are not actively writing a check for the good or service, as they would another significant purchase such as a house or a car. Such lack of awareness allows for a setting where clients can be paying more than they understand for said service. Although there is much reading and attention on about “fees,” there currently no publicly available commonly accepted method on calculating an investor's “all-in” cost. This cost is a significant annual expense, particularly in the $5M plus in investable assets, becomes a major cost over the life of the client and portfolio. Identifying, aggregating and calculating these expenses can be both costly and timely. Thus, there is a need for a system that executes a process which is a more efficient and scalable solution so that a broader range of clients can receive the benefits of said analysis. Particularly, a system that performs a comprehensive and all-encompassing analysis of a client's wealth management relationship with the managing banks.

### SUMMARY OF THE INVENTION

The present invention provides systems and methods for processing account data from multiple server platforms that are associated with a retail investor's wealth management portfolio. According to one embodiment, the system comprises a processor, and a memory having executable instructions stored thereon that when executed by the processor cause the processor to retrieve and aggregate account information data, such as account identifier (ID) or number, name, positions, transaction history along with securities data (security type, name, CUSIP, current and historical pricing). The account information data is normalized to a schema so that the information can be analyzed and certain fees can be calculated based on account and asset types. The processor may further procure market data from various sources, compare pricing and transaction data from third-party market data providers. The processor may then generate an all-in cost based on the calculated fees, compare the all-in cost with a proprietary database of industry standard data and market and pricing data from third-party providers (e.g., from investment research firms), and electronically generate recommendations based on the comparison.

In one embodiment, the account and asset types include taxable brokerage accounts, qualified accounts, managed/wrapped account, stocks, bonds, exchange-traded funds, mutual funds, alternative investments, and options. The industry standard data may include management fee by asset type and relationship size along with fee breakpoint schedules associated with such. The industry standard data may further include a comparison of the management fees between corporate bonds, treasuries and municipal bonds. The industry standard data may also include equity trading costs, bond mark-ups (on purchases), and mark-downs (on sales). The system may further comprise a social networking platform that connects like-profiled investors.

According to another embodiment, the system comprises a processor, and a memory having executable instructions stored thereon that when executed by the processor cause the processor to retrieve account information data from a financial institution server by using a client data aggregator that accesses the account information data at the financial institution server through an application programming interface, or directly from the financial institution server when no aggregator is available, and normalize the account information data to a schema by formatting the retrieved data into data fields suitable for processing according to a given data format, analyze the normalized account information data on the basis of cost and quality by using market data from a third-party database, compare the analysis of the normalized account information data with data from a industry standards database, generate a report on findings based on the comparison, and generate recommendations based on the report.

The processor may be further configured to compute an all-in cost based on the normalized account information data, the third party market data and the data from the industry standards database. The processor may also compute the all-in costs at an account level, a securities level, and a transaction based level. The processor may be further configured to compare the all-in cost with the analysis of the normalized account information data. The processor may also compare the all-in cost with the analysis of the normalized account information data based on account type, asset types and account sizes. In one embodiment, the processor may be further configured to compare the all-in cost with the analysis of the normalized account information data based on what is reported to a client corresponding to the account information data by an advisor or financial institution. In another embodiment, the processor may be further configured to compare the all-in cost with the analysis of the normalized account information data based on a client contract from inception of an account corresponding the account information data. In yet another embodiment, the processor may be further configured to compare the all-in cost with the analysis of the normalized account information data based on the market data from the third-party database including market bid and offers prices on securities at time of trade.

The account information data may include taxable brokerage accounts, qualified accounts, managed/wrapped accounts, single stock positions, bonds, exchange-traded funds, mutual funds, alternative investments, and options. The processor may be further configured to organize the account information data into investment holdings, a summary of the investment holdings, and transaction details. The account information data may include an account identifier or number, name, security positions, and securities data. The industry standards database may include management fee by asset type, relationship size data, and breakpoint schedules associated with such. The industry standards database may include management fees between corporate bonds, treasuries and municipal bonds data. The industry standards database may also include equity trading costs, and bond mark-ups/downs.

According to one embodiment, the method comprises retrieving, by an analysis server, account information data from a financial institution server by using a client data aggregator that accesses the account information data at the financial institution server through an application programming interface. The account information data is normalized to a schema by the analysis server by formatting the retrieved data into data fields suitable for processing according to a given data format. The method further comprises the analysis server retrieving market data from a third-party database, analyzing the normalized account information data on the basis of cost and quality by using the market data, comparing the analysis of the normalized account information data with data from a industry standards database, generating a report on findings based on the comparison, and generating recommendations based on the report.

The method may further comprise computing an all-in cost based on the normalized account information data, third party market data to include securities trading details and pricing, and the data from the industry standards database. The all-in costs may be computed at an account level, a security level, and a transaction based level. The all-in cost may be compared with the analysis of the normalized account information data.

The present invention further includes non-transitory computer-readable media comprising program code that when executed by a programmable processor causes execution of a method for processing account data from multiple server platforms that are associated with a retail wealth management investor's portfolio. According to one embodiment, the computer-readable media comprises computer program code for retrieving account information data from a financial institution server by using a client data aggregator that accesses the account information data at the financial institution server through an application programming interface, or directly from the financial institution server when no aggregator is available, and computer program code for normalizing the account information data to a schema by formatting the retrieved data into data fields suitable for processing according to a given data format, computer program code for retrieving market data from a third-party database, computer program code for analyzing the normalized account information data on the basis of cost and quality by using the market data, computer program code for comparing the analysis of the normalized account information data with data from a industry standards database, computer program code for generating a report on findings based on the comparison, and computer program code for generating recommendations based on the report.

The non-transitory computer-readable media may further comprise computer program code for computing an all-in cost based on the normalized account information data, third party market data, and the data from the industry standards database and computer program coder for comparing the all-in cost with the analysis of the normalized account information data.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a computing system according to an embodiment of the present invention.

FIG. 2 illustrates a flowchart of a method for identifying costs related to a retail investor's portfolio according to an embodiment of the present invention.

FIG. 3 illustrates a data flow diagram of a computing system according to an embodiment of the present invention.

FIG. 4A through 4C illustrate an exemplary client report on single stock trading analysis according to an embodiment of the present invention.

FIG. 5A through 5C illustrate an exemplary client report on managed account analysis according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software (including mobile device applications), firmware or any combination thereof (other than software per se). The following detailed description is, therefore, not intended to be taken in a limiting sense.

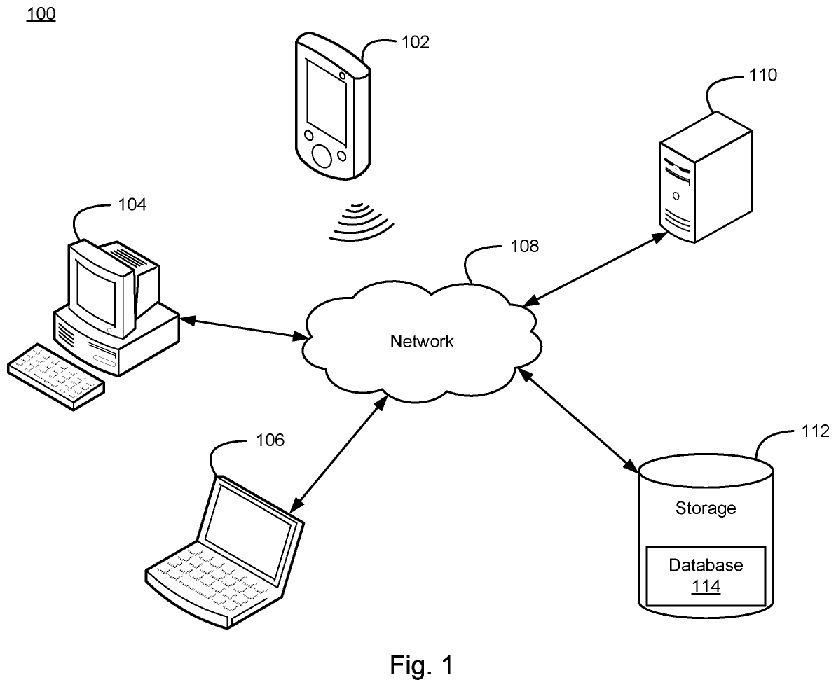

FIG. 1 illustrates a computing system according to an embodiment of the present invention. The system 100 presented in FIG. 1 includes client device 102, client device 104, client device 106, network 108, analysis server 110, and storage device 112. Client devices 102, 104, and 106 may comprise computing devices (e.g., desktop computers, terminals, laptops, personal digital assistants (PDA), cellular phones, smartphones, tablet computers, e-book readers, smart watches and smart wearable devices, or any computing device having a central processing unit and memory unit capable of connecting to a network). Client devices may also comprise a graphical user interface (GUI) or a browser application provided on a display (e.g., monitor screen, LCD or LED display, projector, etc.). A client device may vary in terms of capabilities or features.

For example, a web-enabled client device, which may include one or more physical or virtual keyboards, mass storage, and a display. A client device may also include or execute an application to communicate content, such as, for example, textual content, multimedia content, or the like. A client device may also include or execute an application to perform a variety of possible tasks, such as browsing, and searching web content. A client device may include or execute a variety of operating systems, including a personal computer operating system, such as a Windows, Mac OS or Linux, or a mobile operating system, such as iOS, Android, or Windows Phone, or the like. A client device may include or may execute a variety of possible applications, such as a client software application enabling communication with other devices, such as communicating one or more messages, such as via email, short message service (SMS), or multimedia message service (MMS).

Network 108 may be any suitable type of network allowing transport of data communications across thereof. The network 108 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine-readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client devices may be encrypted using, for example, the Advanced Encryption Standard (AES) with a 128, 192, or 256-bit key size, or any other encryption standard known in the art.

Analysis server 110 may comprise computer logic configured to perform calculation and recommendation operations as disclosed herein. The analysis server 110 is operative to receive requests from client devices 102, 104, and 106 and process the requests to generate responses to the client devices across the network 108. A given request may comprise a user requesting to provide account information data to analysis server 110 to perform analysis (such as account identifier (ID) or number, name, securities holding, transaction history and securities data including asset type, name, CUSIP, current and historical pricing). The analysis of the account information data may then be reconciled to time and price information from third party market data. Analysis and recommendations of account information data may be generated by analysis server 110 and stored to database 114 on storage device 112. Further requests may include a request to view a result of analysis and recommendations corresponding to given account information data.

A server, as described herein, may comprise at least a special-purpose digital computing device including at least one or more central processing units and memory. Analysis server 110 may also include one or more of mass storage devices, power supplies, wired or wireless network interfaces, input/output interfaces, and operating systems, such as Windows Server, Mac OS X, Unix, Linux, FreeBSD, or the like. In an example embodiment, the analysis server 110 may include or have access to memory or computer readable storage devices for storing instructions or applications for the performance of various functions and a corresponding processor for executing stored instructions or applications. For example, the memory may store an instance of the analysis server 110 configured to operate in accordance with the disclosed embodiments.

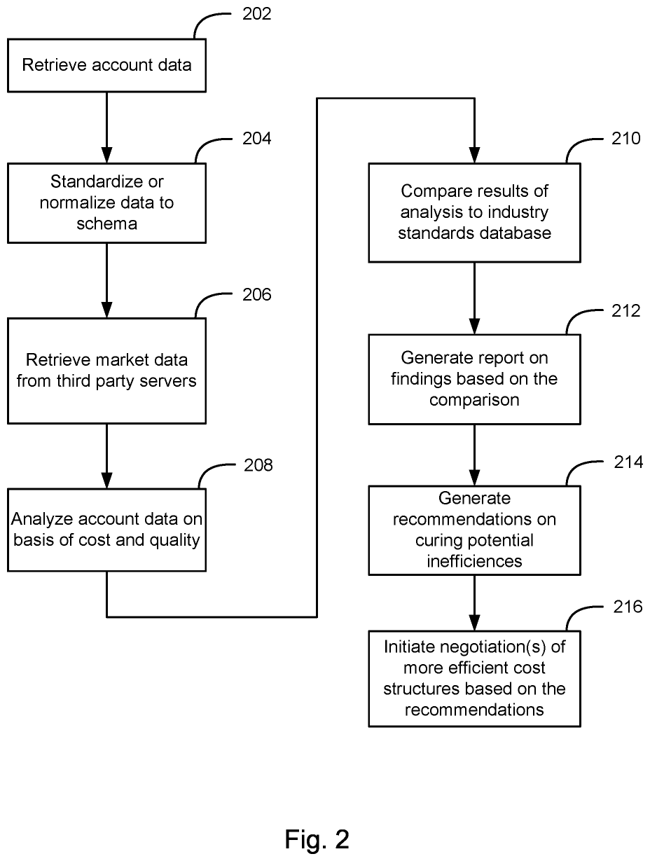

FIG. 2 presents a flowchart of a method for identifying costs related to a retail investor's portfolio. An owner of the portfolio may allow electronic access to one or more accounts of the portfolio at one or more financial institution servers. Account information data is retrieved by the disclosed computing system (e.g., via a computing device or server) in step 202. Retrieving account information data for one or more accounts may include retrieving/importing investment holding entries data from accounts at each investment firm managing the retail investor's portfolio.

The account information data may include account, holding, security, and transactions data for the one or more accounts from financial institution servers. For example, the retrieved data may comprise:

Client Portfolio Data
a. List and attributes of each of investment accounts
   i. Account ID, Name
   ii. Asset Type (s)
   iii. Securities Holdings (including securities data such as CUSIP , quantity, current and historical pricing, cost basis)
   iv. Fee Structure
b. Transaction details of each investment account
   Based on the retrieved account information data, the disclosed computing system may either generate a point in time snapshot of one or more accounts, which may then be annualized, or retrieve historical actuals for a stated period of time, such as the past year, which may then be calculated to attain an annual number for further analysis and comparison.

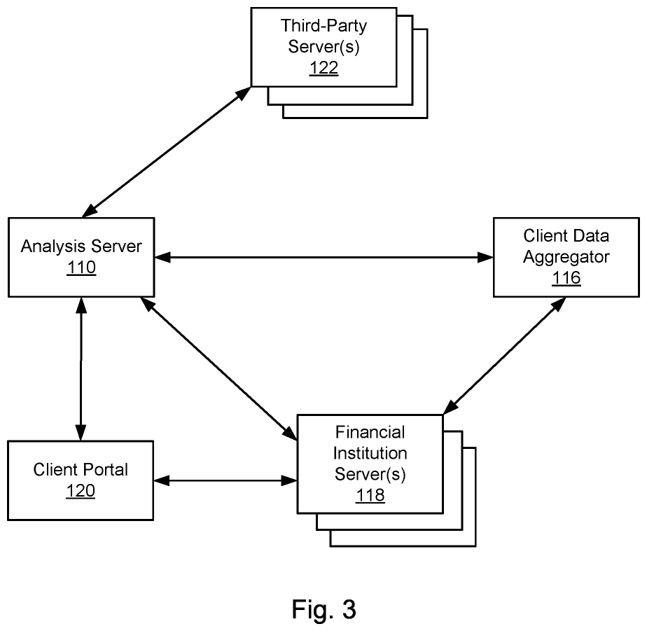

Referring to FIG. 3, the disclosed computing system may include an analysis server 110 that is configured to obtain the account information data for the one or more accounts from financial institution server(s) 118 via a client data aggregator 116. The client data aggregator 116 may comprise an application programming interface (“API”) that is able to access and aggregate account data from financial institution server(s) 118 and transmit the account data to analysis server 110. Alternatively, by using a client's login credentials if provided, financial institution server(s) 118 may upload account information data in a transaction file directly to analysis server 110 via a data request by analysis server 110 or the transaction file may be downloadable from a client portal 120 that is provided by the financial institution server(s) 118. According to another embodiment, the disclosed computing system may perform screen scraping/web automation technologies to “act on behalf of” a client to download their data from financial institution portals.

Referring back to FIG. 2, account information data received by the analysis server 110 may be parsed from transaction files of various formats and standardized or normalized to a schema, step 204. The financial institution server(s) 118 may include various server platforms that utilize different data formats that can be standardized or normalized to a format that is suitable for processing by analysis server 110. Standardizing or normalizing the data may include parsing, extracting, formatting and/or organizing the retrieved data into data fields or a format suitable for processing. A file format definition may also be loaded for mapping or formatting the data into a suitable file or data format for the analysis server. In one embodiment, the retrieved data may be formatted into investment holdings and a summary of the holdings along with transaction details of the one or more accounts.

Market data is retrieved by the analysis server 110 from third-party server(s) 122 including a database (e.g., from investment research firms, market data firms, investment banks and account aggregators, such as Bloomberg, Morningstar, etc), step 206. The market data may include, for example, securities data including security type, name, CUSIP, quantity held, current and historical pricing. Additional market data that may be retrieved are disclosed in the Appendix.

### Calculations

Various fee calculations may be performed on the account information data for each fee type based upon both the account type and the asset type. Fees that were actually charged for each holding are determined and annualized. Depending on the type of holding or how the fees are reported, this may require derivation from other data (e.g., management fees vs. per transaction fees). Analysis of the normalized account information data on the basis of cost and quality may be performed in step 208 via computer artificial intelligence and machine learning by the analysis server according to the market data which may then be used to generate reports that are described in further detail herein.

Taxable Brokerage or Qualified accounts—this can be an investment account that holds securities, usually where an advisor may or may not take discretion on the account. The transaction costs in these accounts tend to be greater as there is no asset-based fee overlay. Hence, the calculations may be as follows:

Stock Trades, mark-ups and commissions can be calculated as the difference in the price from where the stock printed to the tape (if transacted in a broker capacity) or where the stock was trading at the time the trade was executed (if transacted in an agency/dealer capacity) and where it is marked in the client account times the number of shares traded. This cost may comprise ticket charges and commissions. Hence, if a client puts a sale order for 1,000 shares of Company A currently trading at $50/share but the price gets marked in his account at $49.90 per share, the client paid $0.10 per share or $100 for the trade. This can usually be discerned by the activity level detail in the client online account and/or statement and/or trade confirmation which may show the commission. Another cost to the retail investor is the quality of trade execution, which is measured by what price the trade actually priced at on the bid or offer side of the current spread. Hence if a sale order is executed at the bid price or a purchase at the offer price, the client also incurs the cost of the spread which is usually dependent on the various factors including the liquidity of that specific security. This can be discerned by gathering third party market data on the bid/offer price detail. As well, it is important to note the percentage of volume the client is participating in, how their executions compare to the volume-weighted average price (“VWAP”) of all shares trading during time the order was active. Often times in managed or wrapped accounts, the transaction costs are minimal, such as a 1-2 cents per share and overlooked by the consumer. However, this can sometimes add substantial basis points to the fee once annualized, particularly in accounts regularly rebalanced to track an index.

Bond trades mark-ups/downs may also be calculated as the difference in the price where the bond printed to the tape (if transacted in a broker capacity) or where the bond was trading at the time the trade was executed (if transacted in an agency/dealer capacity) and where it marked in the client account plus or minus any accrued interest on the bond. This difference is then applied to the number of bonds as the basic unit of most bonds is 1,000 with the par value being 100. Hence, if a client puts in a purchase order for $50,000 (quantity of 50 bonds) of a corporate or municipal bond that is trading at a premium of 101.25 (or $1,012.50 per bond versus par of $1,000), yet the client gets marked in his account at 102.25, the client has paid $1022.50 for the been charged an execution costs of $10 per bond or $500 for the trade. Access to market data and an understanding of pricing, accrued interest and amortization may be used to perform this calculation.

Exchange-traded funds (“ETFs”) costs may be the value of the client's position times the expense ratio. These costs are taken out of net asset value (“NAV”) daily.

Mutual funds costs as commonly known, may be calculated differently based on their share class, the most common are:
A—client pays up-front fees, or load going into the position plus fees of the asset value times the stated annual expense ratio (this is deducted from NAV daily so it will not be a separate line item in transaction level detail in the account);
B—client pays no fee/load going into the position, but is subject to a contingent deferred sales charge (“CDSC”) upon exiting the position, which may be determined by the period of length the client retained the position. While holding the position, the client pays fees of the asset value times the stated annual expense ratio (this is deducted from NAV daily so it will not be a separate line item in transaction level detail in the account);
C—client may pay a fee to get out of the position if not held over one year, but is subject to CDSC plus the fees of the asset value times the stated annual expense ratio, (this is deducted from NAV daily so it will not be a separate line item in transaction level detail in the account); and
Y/I—(institutional share class) these have no up-front loads nor CDSC—are commonly used for institutional accounts or retail accounts, when held in a managed account. The fees of the asset value times the stated annual expense ratio may be deducted from NAV daily so it will not be a separate line item in transactions level detail in the account.

Alternative Investments may takes the shape of a fund structure within a client's brokerage account. The various costs for these are often embedded in the investment memo and may include:
1) Origination fee—an upfront commission paid to the selling bank (stated percentage times the full capital commitment, may not come out of cost basis and can be a separate transaction in account detail);
2) Management fee—an annual and ongoing expense paid to the manager and the bank (stated fee percentage times capital commitment, usually charged full-boat even if the capital is not deployed yet);
3) Conduit expenses

Options—this is usually a commission charged for the trading of the options, unless held in a managed account where no significant transaction costs should be imposed.

Managed/wrapped accounts—this may be an account type subject to an annual ongoing fee usually charged quarterly, in either arrears or advance, with an advisor possibly taking discretion on the account so that it can be managed in-house or by a third party asset manager. Typically, there should be no transaction costs in these accounts, but it has been found to happen and easily overlooked. The asset based fee is usually the largest fee in the account, dependent upon relationship size with the investment bank, given their fee breakpoint schedules and may be calculated according to the following: Base account value (“BAV”) times annual fee percentage divided by 4 to represent the quarter; or BAV account value times 25% of the annual fee. BAV is usually the account value at the time the fee is charged or prior month ending balance. Some banks average out the prior three months value to derive BAV. The fee in the account may be charged as above in one line item or broken out in two line items to show the fee to the third party manager separately.

### Comparison

Results of the account information data analysis are compared to current industry/market standards data from an industry standards database, step 210. The comparison may be based on:
1) industry standards based on account type, asset types and account sizes (e.g., from a proprietary database);
2) what is being currently reported to the client by his advisor/bank (e.g., retrieved from the client data aggregator 116 or from client portal 120);
3) the client contract from account inception (e.g., web services that can read document files); and
4) market data sources which provide market bid and offers prices on securities at time of trade that helps to discern true trading costs and quality of executions. This may be particularly relevant when the investor has significant institutional size holdings.

The current industry/market standards data may include data, such as:
1) Asset type and characteristics—e.g., management fee of corporate bonds vs. treasuries vs. municipal bonds;
2) Equity trading costs (may be on a per share basis);
3) Bond mark-ups/downs;
4) Asset based fees based on relationship/account size and breakpoint fee schedules;
5) Fee structure/average fees/costs by asset type; and

Performing the comparison may include calculating and annualizing costs based on current industry/market standards data using parameters from the account information data (e.g., asset types, transactions), both in dollar and percentage terms. The weighted average for the percentage terms may be calculated and an all-in cost based on the current industry/market standards data may be calculated by adding up all of the dollars. Fees that should have been charged for each holding are determined. This may depend on the type of the holding and the structure of fees associated with that type. The industry average for each holding are determined (where appropriate).

The results of the all-in cost based on the current industry/market standards data can then be compared with the account information data analysis. The all-in cost may also include fees at the account level, security level and transaction based level. The fees can be generated by the disclosed computing system as line items at the transaction level in an investment account detail.

For each transaction, the published price of the securities bought/sold at the time of the transaction may be determined. Areas where the purchase/sale price recorded don't match published price at that point in time may be identified. Areas where the client was overcharged fees (according to their agreements) or whether they were charged correctly, but where those fees exceed (or are lower than) the industry average may be identified. Findings of the comparisons of the analysis with the current industry/market standards data are generated into one or more reports, step 212.

The following include additional comparisons and/or analysis that may be performed electronically by the disclosed computing system and added to the report:

Account maintenance fees—charges for just opening and maintaining the accounts which are usually waived at certain asset levels.

Margin interest—ensure that margin interest is only being charged where there is no cash in the client's other accounts available for use to cover the cost of positions that may need to be levered.

Cash check—total cash balances in all wrapped/managed accounts to compare as a percentage of total account values. Multiply that by the annual management fee to ensure the client isn't being charged to sit in cash—this is a practice easily overlooked by the consumer.

Cash check—Compare rate-of-return in money market to all available options in and out of house.

FINRA broker check—cross check advisor name with FINRA website to ensures no egregious offenses committed prior by the advisor that harmed prior clients due to their lack of ability, experience, and/or integrity.

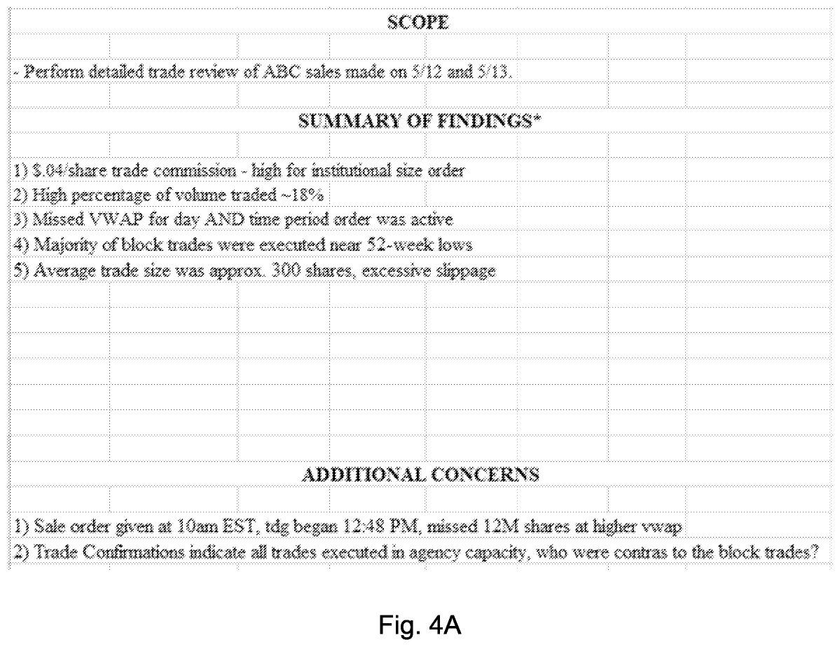

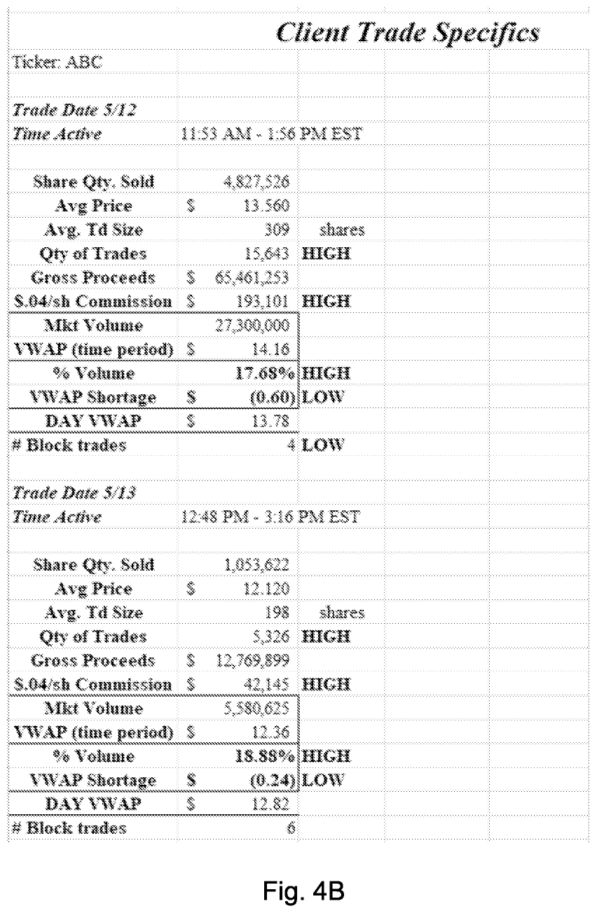

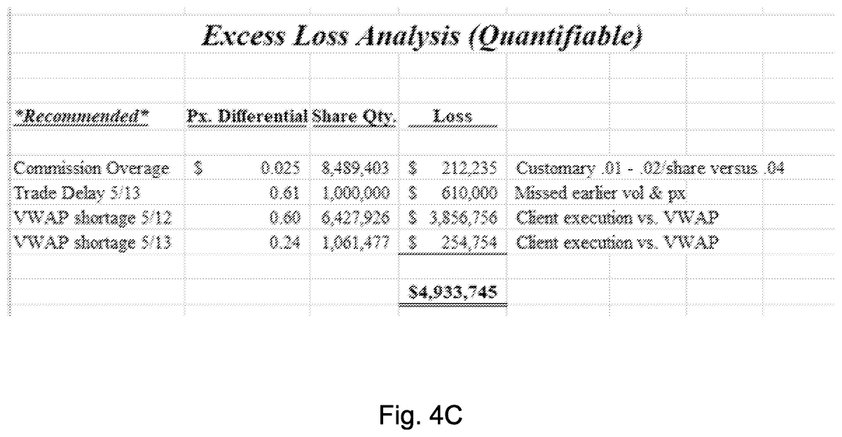

FIG. 4A through 4C illustrate an exemplary client report on single stock trading analysis according to an embodiment of the present invention. The illustrated client report may be generated by the disclosed system based on comparisons and analysis regarding an account's stock trades, mark-ups and commissions.

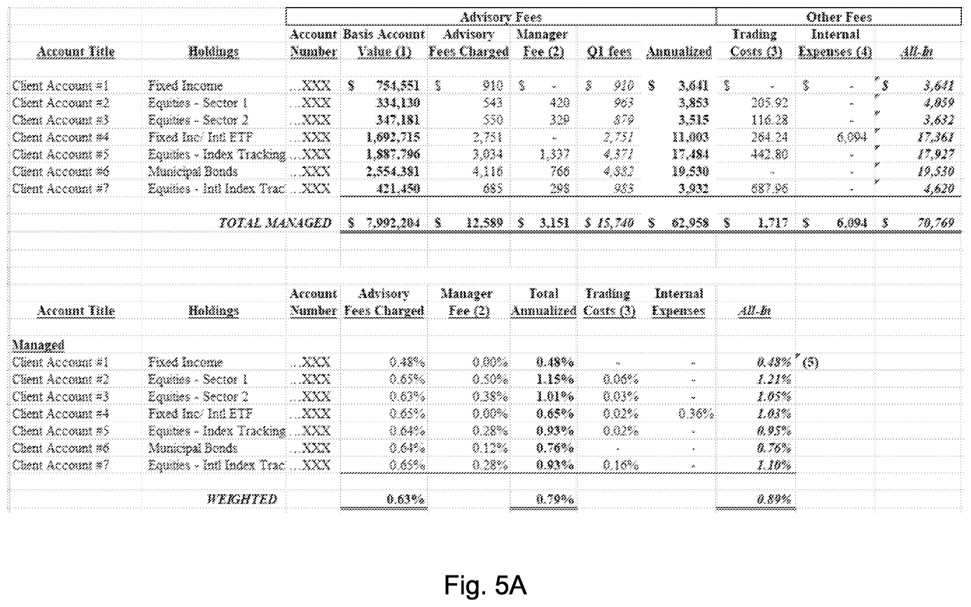

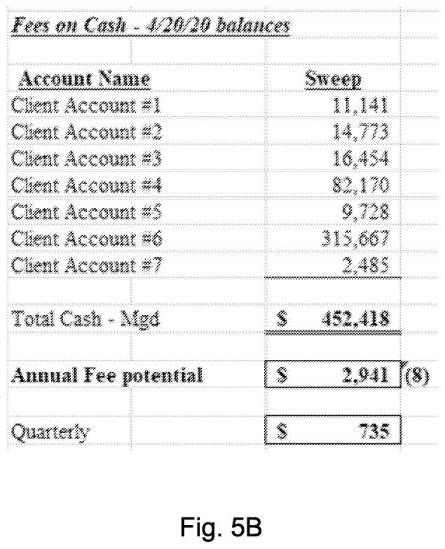

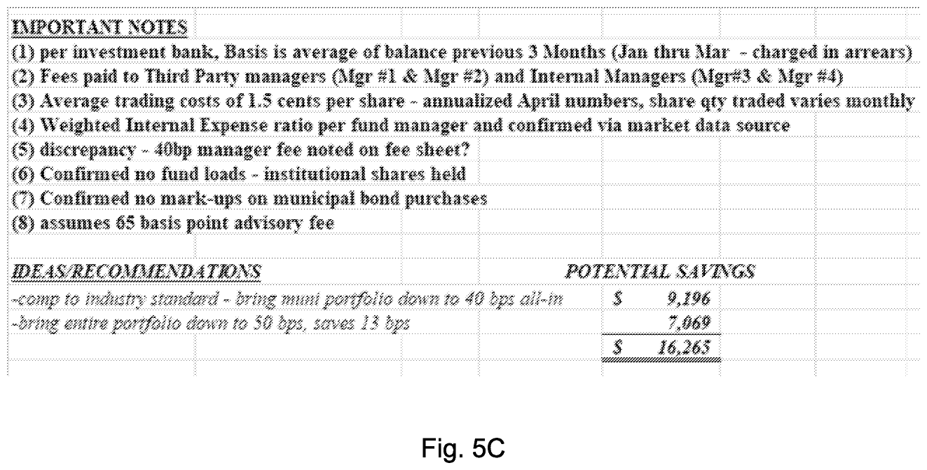

FIG. 5A through 5D illustrate an exemplary client report on managed account analysis according to an embodiment of the present invention. The illustrated client report may be generated by the disclosed system based on comparisons and analysis of an advisory fee based managed portion of a client's portfolio. As an example, the methods disclosed herein may be used to analyze a client's financial life after the sale of her privately held business (“Private Company X”) to a public company. The analysis may include auditing her investment accounts, both taxable and qualified, which she has spread across three investment banks.

This analysis may ensure that all facets of the client's financial life are well organized, well understood and operating efficiently and optimally in her best interest. In the example, the most important exercise may include an audit of her 13 investment accounts which is intended to bring full transparency to the client. Various fees related to her investment accounts may be identified. This includes, but is not limited to, asset-based advisory fees, transaction costs and expense ratios. That information may then be compared to industry standards at large and used to determine how to reduce any potentially excessive fees and/or drag on her portfolio performance.

Various methods may be used to perform said analyses. The client may provide information along the way and grant access to view all of her investment accounts on-line or through third-party aggregators such as a financial technology platform provided by Plaid when available. This allows all of the fees and transactions being charged to her accounts to be retrieved and analyzed. Various market data sources may be used to find stock and bond transaction pricing and fund expense ratios.

### Exemplary Findings and Recommendations

Recommendations on curing potential inefficiencies are generated based on the one or more reports, step 214. The recommendations may include areas that are good candidates for renegotiation or based on findings.

1) Investment Accounts—the disclosed computing system may identify that the client is currently paying approximately $127,000 all-in costs related to her investments annually. Overall, should the system determine a reduction in costs is fair and justified as noted below, this may save the client about 7% annually post-tax. This translates to approximately $800,000 that she will save and on her own balance sheet, versus the bank, over the life expectancy of her portfolio as it is currently allocated. This number assumes the savings are re-invested in her current fixed income portfolio, net of his municipal bonds, yielding about 4% annually. In this example, the client does not carry significant cash balances in her managed accounts which can lead to unnecessary fees.

a. Bank One—

i. The fee for her managed municipal bond account was found to be well over the industry average for a relationship of similar size. This may be reported and queried for working to reduce the fee in the municipal bond account by over 20 basis points.

ii. After breaking out all third-party management fees, it was found that the advisory fee being charged by the bank on a quarterly basis was approximately 25% over what was currently being reported to her. This may be reported and queried to provide an explanation of how this number may be reduced in the near future.

iii. Trading costs in a managed account were identified. Overall, these were not significant enough in this example to negotiate, however it did add a notable 20 plus basis points (annualized) to one of the separately managed accounts.

iv. The system may identify significant costs related to an alternative investment fund holding, whereas the fees charged to date were over $20,000 on a $500,000 capital commitment of which was not yet fully invested. Some of these were one-time fees and should not repeat annually.

b. Bank Two —Weighted all-in costs of about 2.08% were identified here. Breakpoint schedules may be created by the system to find a potential 40-basis point reduction in the current advisory fees being charged. This may be reported and queried to reduce this.

c. Bank Three—Weighted all-in costs of 1.42% were identified. While the fee percentage is more than Bank One, it is a very small percentage of the client's assets.

Other Items/Recommendations—Prior to analysis by the disclosed computing system, the client confirms that he has taken measures in other vital areas such as cyber security and credit protection. Given all of the assets owned, a comprehensive review of all insurances may be recommended.

Negotiation(s) of lower more efficient cost structures based on the recommendations are initiated by the disclosed computing system, step 216. In addition to significant cost savings, the client may be provided with better information to help make decisions using some of the more granular and/or non-transparent details of her financial life. Going forward, the disclosed computing system may continue to work with the client's accounts to have the fees lowered as noted above and the client may monitor this over time individually or via an interface provided by the disclosed computing system. The system may further coordinate all the different subsectors of his financial picture to ensure her best interest is always maintained at the forefront.

FIGS. 1-5C are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

### APPENDIX

### Addendum: Securities Data Points

### All Securities

Committee on Uniform Securities Identification Procedures (“CUSIP”) Number
Company Description
Industry
Asset Type

### Stock/Fund Information

Stock Price at Point in Time (minute granularity)
Daily volume weighted average price (“VWAP”)
Trading Volume leaders
Historical pricing data
volatility

### Bond

Company description
Description to include coupon rate and maturity date, call date etc
Price at Point in Time (daily average granularity or better)
Credit rating (which rating agency)
Trading Volume leaders
Historical pricing data

### Mutual Funds

Description of strategy/holdings
Rating (morningstar or other)
fees—sales loads and expense ratios
Historical pricing data

### Expense Ratio/Sales Load

### Money Market Funds

Function that shows/compares rates around the industry

### General—Markets/Indices (S&P, Russell, Dow Jones, Nasdaq, etc., VIX)

Historical pricing
Volatility
Stocks Components that make up indices

### General—Fixed Income Markets (Bonds—Treasuries, Municipals, Corporate)

Current and historical yields
Trading volume

What is claimed is:

1. A system for processing account data from multiple server platforms that are associated with a retail wealth management investor's portfolio, the system comprising:
a processor; and
a memory having executable instructions stored thereon that when executed by the processor cause the processor to:
retrieve account information data from a financial institution server by using a client data aggregator that accesses the account information data at the financial institution server through an application programming interface;
normalize the account information data to a schema by formatting the retrieved data into data fields suitable for processing according to a given data format;
retrieve market data from a third-party database;
analyze the normalized account information data on the basis of cost and quality by using the market data;
compare the analysis of the normalized account information data with data from a industry standards database;
generate a report on findings based on the comparison; and
generate recommendations based on the report.

2. The system of claim 1 wherein the processor is further configured to compute an all-in cost based on the normalized account information data and the data from the industry standards database.

3. The system of claim 2 wherein the processor is further configured to compute the all-in costs at an account level, a security level, and a transaction based level.

4. The system of claim 2 wherein the processor is further configured to compare the all-in cost with the analysis of the normalized account information data.

5. The system of claim 4 wherein the processor is further configured to compare the all-in cost with the analysis of the normalized account information data based on account type, asset types and account sizes.

6. The system of claim 4 wherein the processor is further configured to compare the all-in cost with the analysis of the normalized account information data based on what is reported to a client corresponding to the account information data by an advisor or financial institution.

7. The system of claim 4 wherein the processor is further configured to compare the all-in cost with the analysis of the normalized account information data based on a client contract from inception of an account corresponding the account information data.

8. The system of claim 4 wherein the processor is further configured to compare the all-in cost with the analysis of the normalized account information data based on the market data from the third-party database including market bid and offers prices on securities at time of trade.

9. The system of claim 1 wherein the account information data includes brokerage accounts, stock trades, bond trades, exchange-traded funds, mutual funds, alternative investments, options, and managed/wrapped accounts.

10. The system of claim 1 wherein the processor is further configured to organize the account information data into investment holdings, a summary of the investment holdings, and transaction details.

11. The system of claim 1 wherein the account information data includes an account identifier or number, name, security positions, and securities data.

12. The system of claim 1 wherein the industry standards database includes management fee by asset type data.

13. The system of claim 1 wherein the industry standards database includes management fees between corporate bonds, treasuries and municipal bonds data.

14. The system of clam 1 wherein the industry standards database includes equity trading costs, bond mark-ups/downs, and account size relationship data.

15. A method, in a data processing system comprising a processor and a memory, for processing account data from multiple server platforms that are associated with a retail wealth management investor's portfolio, the method comprising:
retrieving, by an analysis server, account information data from a financial institution server by using a client data aggregator that accesses the account information data at the financial institution server through an application programming interface;
normalizing, by the analysis server, the account information data to a schema by formatting the retrieved data into data fields suitable for processing according to a given data format;
retrieving, by the analysis server, market data from a third-party database;
analyzing, by the analysis server, the normalized account information data on the basis of cost and quality by using the market data;
comparing, by the analysis server, the analysis of the normalized account information data with data from a industry standards database;
generating, by the analysis server, a report on findings based on the comparison; and
generating, by the analysis server, recommendations based on the report.

16. The system of claim 15 further comprising computing an all-in cost based on the normalized account information data and the data from the industry standards database.

17. The system of claim 16 further comprising computing the all-in costs at an account level, a security level, and a transaction based level.

18. The system of claim 16 further comprising comparing the all-in cost with the analysis of the normalized account information data.

19. Non-transitory computer-readable media comprising program code that when executed by a programmable processor causes execution of a method for processing account data from multiple server platforms that are associated with a retail wealth management investor's portfolio, the computer-readable media comprising:
computer program code for retrieving account information data from a financial institution server by using a client data aggregator that accesses the account information data at the financial institution server through an application programming interface;
computer program code for normalizing the account information data to a schema by formatting the retrieved data into data fields suitable for processing according to a given data format;
computer program code for retrieving market data from a third-party database;
computer program code for analyzing the normalized account information data on the basis of cost and quality by using the market data;
computer program code for comparing the analysis of the normalized account information data with data from a industry standards database;
computer program code for generating a report on findings based on the comparison; and
computer program code for generating recommendations based on the report.

20. The non-transitory computer-readable media of claim 19 further comprising:
computer program code for computing an all-in cost based on the normalized account information data and the data from the industry standards database; and
computer program coder for comparing the all-in cost with the analysis of the normalized account information data.
